(19) United States
(12) Patent Application Publication
(10) Pub. No.: US 2018/0240153 A1
(43) Pub. Date: Aug. 23, 2018

(54) BEACON IMPLEMENTATION

(71) Applicant: Empire Technology Development LLC, Wilmington, DE (US)

(72) Inventor: Seungil Kim, Seoul (KR)

(73) Assignee: Empire Technology Development LLC, Wilmington, DE (US)

(21) Appl. No.: 15/545,448

(22) PCT Filed: Jan. 22, 2015
(86) PCT No.: PCT/US2015/012363

§ 371 Date: Jul. 21, 2017

(51) Int. Cl. G06Q 30/02; G06Q 20/32; H04W 4/021

(52) U.S. Cl. CPC G06Q 30/0261; G06Q 30/0224; H04W 4/021; G06Q 20/3224; G06Q 30/0281

(57) ABSTRACT

Technologies are generally described for a beacon implementation scheme. In some example, a method performed under control of a server may include receiving, from a plurality of mobile devices over a period of time, location information that identifies a point of interest; determining a number of times that location information identifying the point of interest has been received from one or more of the plurality of mobile devices; and implementing a beacon based on the number of times that location information identifying the point of interest has been received.

### BACKGROUND

Beacon applications may enable a customer, e.g., a device user, to automatically check-in at or near a shop using a beacon signal, thus providing the customer with convenient payment options and personalized location-based advertising features. For example, when a user's device executes or runs a beacon application when he/she passes by a point of interest such as a restaurant, and a beacon installed at the restaurant is detected by the beacon application, the user's device may receive information such as current special menu options or coupons.

### SUMMARY

In an example, a method performed under control of a server may include receiving, from a plurality of mobile devices over a period of time, location information that identifies a point of interest; determining a number of times that location information identifying the point of interest has been received from one or more of the plurality of mobile devices; and implementing a beacon based on the number of times that location information identifying the point of interest has been received.

In another example, a server may include a receiver unit, a determination unit and an implementation unit. The receiver unit may be configured to receive, from a plurality of mobile devices, location information that identifies a point of interest. The determination unit may be configured to determine a number of times that location information identifying the point of interest has been received from one or more of the plurality of mobile devices. The implementation unit may be configured to implement a beacon based on the number of times that location information has been received.

In yet another example, a computer-readable storage medium may store thereon computer-executable instructions that, in response to execution, cause a server to perform operations. The operations may include receiving, from a plurality of mobile devices over a period of time, location information that identifies a point of interest; determining a number of times that location information identifying the point of interest has been received from one or more of the plurality of mobile devices; and implementing a beacon based on the number of times that location information identifying the point of interest has been received.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 shows an example environment in which a server may be configured to receive location information from a mobile device, arranged in accordance with at least some embodiments described herein;

FIG. 2 shows an example environment in which a server may be configured to implement a beacon based on a number of times that location information has been received, arranged in accordance with at least some embodiments described herein;

FIG. 3 shows a block diagram of an example server configured to implement a beacon, arranged in accordance with at least some embodiments described herein;

FIG. 4 shows a block diagram of another example server configured to implement a beacon, arranged in accordance with at least some embodiments described herein;

FIG. 5 shows a block diagram of an example beacon implementation manager configured to implement a beacon, arranged in accordance with at least some embodiments described herein;

FIGS. 6A-6C illustrate databases of a server that may be used for determining the number of times that location information identifying a point of interest has been received, arranged in accordance with at least some embodiments described herein;

FIG. 7 shows an example flow diagram of a process to implement a beacon, arranged in accordance with at least some embodiments described herein;

FIG. 8 illustrates an example computer program product that may be utilized to implement a beacon, arranged in accordance with at least some embodiments described herein; and

FIG. 9 is a block diagram illustrating an example computing device that may be utilized to implement a beacon, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the drawings, can be arranged, substituted, combined, separated, and designed in a wide variety of different configurations, all of which are explicitly contemplated herein.

This disclosure is generally drawn, inter alia, to methods, apparatuses, systems, devices, and computer program products related to beacon implementation.

In some examples, at least one mobile device may be operable to host, execute and run a beacon application. As part of executing or running the beacon application, the mobile device may transmit the location information of the mobile device to a server that may be configured provide beacon related services based on the received location information. The server may include, as non-limiting examples, a beacon service managing server, which may provide a beacon application that can be downloaded by the plurality of mobile devices and/or provide beacon services associated with the beacon application; an advertisement managing server, which may provide advertisement services based on the received location information via the beacon application; or any other commerce-related servers, which may provide commercial services based on the received location information via the beacon application. The location information may be provided to the server in some form of identification of a point of interest. The identification of the point of interest may include, as non-limiting examples, a name and/or street address of a business establishment, a name and/or street address of a landmark, etc. Alternatively or in addition, the location information may be provided to the server in the form of geographical coordinates such as a global positioning system (GPS) coordinates.

Based on the received location information, the server may count or determine a number of times that location information identifying the particular point of interest has been received within a predetermined period of time, which may be measured in terms of e.g., minutes, hours, days, and/or weeks. Based on the determined number of times that location information identifying the point of interest has been received, the server may implement a beacon or the server may make no changes. Regarding the latter, the server makes a determination that implementation of a beacon at the identified point of interest may not be presently advantageous or warranted.

By way of example, but not limitation, if the number of times that location information identifying the point of interest has been received is counted or determined to be larger or greater (in this context, the terms “larger” and “greater” are used interchangeably herein) than a predetermined value, the server may transmit a message suggesting, recommending, and/or instructing installation of a beacon at the identified point of interest to a beacon system provider or a merchant at the point of interest. The message regarding installation of beacon may indicate that an expected number of potential customers having user devices that host, execute and/or run a beacon application may exceed the predetermined value, which may be effective to induce the merchant to install a beacon at the point of interest for advertisement purposes. In effect, the message may indicate that potential business may justify installation of the beacon. Additionally, the server may provide a consumer reward (e.g., a coupon or reward points) to the mobile device that has transmitted the location information to the server. In this manner, a user of the mobile device may be motivated to visit the point of interest again, which benefits the point of interest.

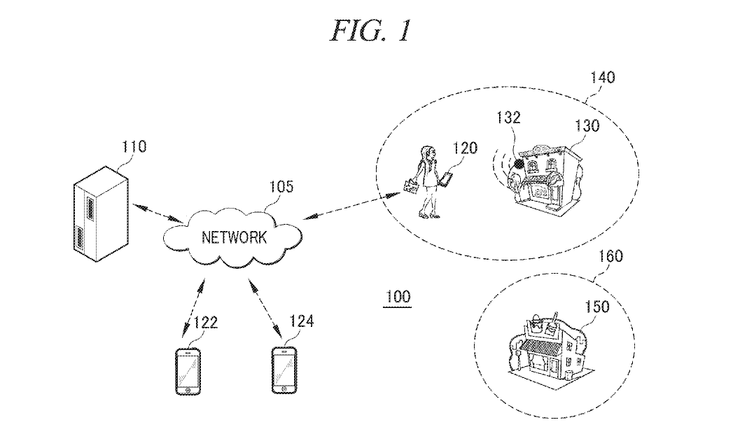

FIG. 1 shows an example environment 100 in which a server may be configured to receive location information from a mobile device that executes and/or runs the beacon application, arranged in accordance with at least some embodiments described herein.

As depicted, a server 110 may be communicatively coupled to a plurality of mobile devices 120, 122, and 124, over a wireless communication network 105. In some embodiments, wireless communication network 105 may employ any suitable wireless technology including, but not limited to, Global System for Mobile communications (GSM), Code Division Multiple Access (CDMA), Long Term Evolution (LTE), Long Term Evolution-Advanced (LTE-A), Worldwide Interoperability for Microwave Access (WiMax), Wireless Fidelity (Wi-Fi) technology and others.

Server 110 may be any type of a computing system configured to receive, store location information and/or count or determine a number of times that location information has been received from one or more of devices 120, 122, 124, etc.

Each of mobile devices 120, 122, 124, etc., may be any type of mobile device configured to host, execute, or run a beacon application and/or transmit location information to server 110. By way of example, but not limitation, mobile device 120 may be a smartphone, a mobile phone, a personal digital assistant (PDA), a tablet computer, a hybrid of the aforementioned devices, a laptop computer, etc. Further, the beacon application that is hosted, executed, or run by the respective mobile devices may be web-based or hosted on the respective device.

In some examples, a first store 130, which may be regarded as a point of interest, located in a first area 140 may have a beacon 132 configured to transmit a beacon signal within first area 140. First area 140 may correspond to an effective range of a beacon signal transmitted from beacon 132, which may be, for example, a few meters to several hundred meters. Also, first area 140 may have a circular coverage as shown in FIG. 1 or any other shape of coverage depending on implementations of beacon 132. Further, first area 140 may be asymmetrical, depending on the natural and/or man-made topography of an area surrounding a point of interest.

The beacon signal may be transmitted in one of various formats including, but not limited to, a short-range wireless communication signal such as a Bluetooth® Low Energy (BLE) based signal, an inaudible signal such as an ultrasonic signal, etc., and may carry commercial information regarding first store 130 in a raw data format or an encrypted data format. For example, if first store 130 is a store, beacon 132 may transmit a beacon signal that carries information regarding first store 130 including, information regarding the store itself, e.g., hours of operation, upcoming promotions; an advertisement; a coupon; commercial reward points; etc. As another example, if first store 130 is a restaurant, beacon 132 may transmit a beacon signal that carries information regarding first store 130 including information regarding the restaurant itself, e.g., hours of operation, upcoming promotions; a menu; a coupon; frequent dining reward points, etc.

When a user of mobile device 120 moves into first area 140 in the direction and/or vicinity of first store 130, the user may cause mobile device 120 to execute and/or run a beacon application that is hosted on mobile device 120, or a web-based version thereof, to receive a beacon signal from beacon 132 of first store 130. When executing or running the beacon application, mobile device 120 may turn on a communication module associated with the beacon application, such as a Bluetooth module, to search for a beacon signal from beacon 132 of first store 130. Then, mobile device 120 may receive the beacon signal from beacon 132 of first store 130.

In some embodiments, server 110 may be configured to receive, from mobile device 120, location information that identifies a point of interest, e.g., first store 130, at which mobile device 120 is located based on a communicative connection between mobile device 120 and beacon 132. In some examples, as part of the beacon application on mobile device 120 executing, or running, mobile device 120 may transmit the location information identifying first store 130 to server 110. Mobile device 120 may transmit the location information identifying first store 130 in response to an operation related to a beacon application hosted on mobile device 120, such as, for example, executing the beacon application; turning on a communication module associated with the beacon application; switching the beacon application from a background mode to an active mode; and/or turning on a beacon signal reception alarm. In further some examples, mobile device 120 may transmit the location information identifying first store 130 together with a flag in response to the operation, which is initiated by the user of mobile device 120, related to the beacon application.

In some other examples, a second store 150, which may be regarded as another point of interest, located in a second area 160 does not have a beacon. In some examples, second area 160 may correspond to a possible transmission range of a beacon signal transmitted from a beacon if such beacon is installed in second store 150. The coverage of second area 160 may be determined by the signal transmission performance of a possible beacon to be installed in second area 150 and be, for example, a few meters to several hundred meters from the possible beacon to be installed in second store 150. Also, the coverage of second area 160 may have a circular shape as shown in FIG. 1 or any other shape of coverage depending on implementations of the beacon. Further, second area 160 may be asymmetrical, depending on the natural and/or man-made topography of an area surrounding a point of interest.

When the user of mobile device 120 moves into second area 160 in the direction and/or vicinity of second store 150, the mobile device 120 may execute or run the beacon application hosted on mobile device 120, or a web-based version thereof. When executing, or running the beacon application, mobile device 120 may also turn on a communication module associated with the beacon application, such as a Bluetooth module. Thus, mobile device 120 may search for a beacon signal from second store 150 using the beacon application, although such beacon signal will not be forthcoming in accordance with the example. Even though mobile device 120 cannot receive a beacon signal within second area 160, mobile device 120 may transmit, to server 110, the location information identifying second store 150 in response to the operation related to the beacon application. Mobile device 120 may transmit the location information identifying second store 150 in response to, for example, executing a beacon application hosted on mobile device 120, turning on a communication module associated with the beacon application, switching the beacon application from a background mode to an active mode, and/or turning on a beacon signal reception alarm. In further some examples, mobile device 120 may transmit the location information identifying second store 150 with a flag in response to the operation related to the beacon application. Thus, server 110 may receive the location information, described below, identifying second store 150 from mobile device 120 located within second area 160. In environment 100 as described above, the point of interest for the user of mobile device 120 may include at least one of first store 130 or second store 150.

Further to the above example, the location information received by server 110 may include geographical coordinates, such as, global positioning system (GPS) coordinates and/or any other type of coordinates. In some examples, server 110 may be configured to receive location information from mobile device 120 and other mobile devices (not shown), which may also be located within second area 160. Although specific geographical coordinates included in the received location information from mobile device 120 may be different from those from the other mobile devices, both the location information of mobile device 120 and the location information of the other mobile devices may identify a same point of interest (e.g., second store 150). That is, server 110 may be configured to not only identify second store 150 based on the geographical coordinates included in the location information received from mobile device 120, but also identify second store 150 based on the geographical coordinates included in the location information received from one or more other mobile devices that are also located within second area 160.

In some embodiments, server 110 may be configured to receive the location information that identifies a point of interest from a plurality of mobile devices over a predetermined period of time. In some examples, the period of time may be preset in terms of e.g., minutes, hours, days, and/or weeks, and may be re-set on a rolling basis. That is, the period of time may be re-set upon occurrence of a reconfigurable designated event, e.g., the most recent identification of a particular point of interest, every day, every hour, etc.

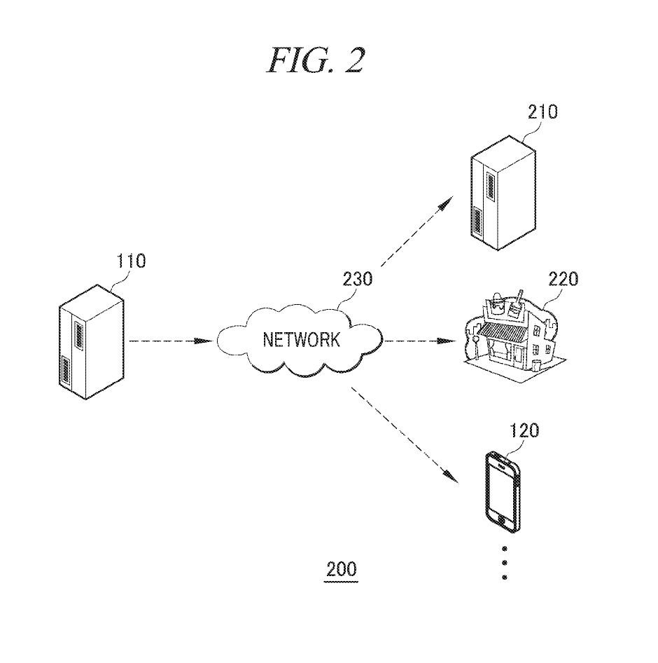

FIG. 2 shows an example environment in which a server may be configured to implement a beacon based on a number of times that location information for a point of interest has been received, arranged in accordance with at least some embodiments described herein.

As depicted, server 110 may be communicatively coupled to a service provider 210, a store 220, mobile device 120, etc. over a communication network 230. For example, communication network 230 may include a wireless network, a cellular network, a wide area network (WAN), a metropolitan area network (MAN), a local area network (LAN), a campus area network (CAN), a virtual private network (VPN), or any combination thereof.

When the user of mobile device 120 moves in the direction and/or vicinity of store 220, the mobile device 120 may execute, or run the beacon application hosted on mobile device 120, or a web-based version thereof. When executing, or running the beacon application, mobile device 120 may also turn on a communication module associated with the beacon application, such as a Bluetooth module. Thus, mobile device 120 may search for a beacon signal from store 220 using the beacon application. Further, mobile device 120 may switch the beacon application from a background mode to an active mode to activate the beacon application. Mobile device 120 may transmit the location information that identifies store 220 in response to an operation related to a beacon application hosted on mobile device 120, such as, for example, executing the beacon application, turning on a communication module associated with the beacon application, switching the beacon application from a background mode to an active mode, and/or turning on a beacon signal reception alarm. In further some examples, mobile device 120 may transmit the location information identifying store 220 with a flag in response to the operation related to the beacon application. Thus, server 110 may receive the location information that identifies store 220, from one or more of a plurality of mobile devices including mobile device 120 located around store 220.

As described above regarding FIG. 1, mobile device 120 may determine that mobile device 120 is in the proximity of the point of interest and then transmit, to server 110, the location information identifying the point of interest, or server 110 may receive, from mobile device 120, the location information indicating that mobile device 120 is in the proximity of the point of interest and determine that the received location information identifies the point of interest.

In some embodiments, server 110 may be configured to count or determine a number of times that location information identifying the point of interest has been received from one or more of a plurality of mobile devices including mobile device 120. In some examples, server 110 may be configured to determine the number of times that the location information has been received, periodically or in a real-time manner. In some examples, store 220 may be the point of interest. Server 110 may be configured to receive location information identifying store 220 from a plurality of mobile devices including mobile device 120, and count or determine a number of times that location information identifying store 220 has been received.

In some examples, server 110 may be configured to, in response to receiving the location information, determine whether the received location information is transmitted in response to the operation related to the beacon application, and count or determine a number of times that location information transmitted in response to the operation related to the beacon application has been received. In further some examples that mobile device 120 transmits location information with a flag in response to an operation related to a beacon application, server 110 may be configured to count or determine a number of times that location information with the flag transmitted in response to the operation related to the beacon application has been received.

In some embodiments, server 110 may configured to implement a beacon based on the number of times that location information identifying the point of interest has been received.

In some examples, server 110 may be configured to notify service provider 210 of the number of times that location information identifying the point of interest has been received from one or more mobile devices. Based on the notified number of times that location information identifying the point of interest has been received from one or more mobile devices, the service provider may provide services, such as, regarding installation of a beacon at the point of interest, a beacon application hosted on the plurality of mobile devices and/or location-based advertisement. By way of example, but not limitation, service provider 210 may include at least one of mobile payment companies associated with the beacon application, location-based advertisement companies, or any other commercial entities.

In some examples, server 110 may be configured to determine whether the number of times that location information identifying the point of interest has been received from one or more mobile devices is greater than a predetermined value, and implement the when the number is greater than the predetermined value. For example, store 220 which does not have a beacon therein may be a point of interest. Server 110 may determine that the number of times that location information identifying store 220 has been received from one or more mobile devices is greater than a predetermined value, although store 220 does not have the beacon. In such case, server 110 may be configured to transmit a message at least recommending installation of a beacon to a computing device located at store 220. The message may be transmitted to at least one of service provider 210, such as a beacon system provider, store 220, or a commercial entity associated with store 220. For example, the message may recommend installation of a beacon at store 220 since the number of mobile devices executing, or running a beacon application within communication range of store 220 would appear to justify the effort and investment to do so.

In some examples, server 110 may be configured to calculate, for the point of interest, a ratio of the number of times that location information received from one or more mobile device identifying the point of interest has been received relative to a floating population around the point of interest over a predetermined period of time. The floating population may be the statistical information obtained from other sources and indicate the proximate number of people that pass around the store 220. In such examples, server 110 may implement the beacon in response to the determination that the calculated ratio is greater than the predetermined value.

For example, for a predetermined period of twenty four (24) hours, if a floating population is 1,000, server 110 receives the location information identifying store 220 from two hundred (200) mobile devices, and the predetermined value is 0.10, then server 110 may obtain information including the floating population from other sources after the predetermined period of 24 hours, divide the number of times that location information identifying store 220 has been received (i.e., 200) by the obtained floating population around store 220, i.e., 1,000, to calculate a ratio over 24 hours, and determine that the calculated ratio is 0.2. Server 110 may determine that the calculated ratio, i.e., 0.2, is greater than the predetermined value, i.e., 0.10, and then implement a beacon, for example, by transmitting a message at least recommending installation of a beacon.

In some examples, server 110 may be configured to generate a report which, for example, may be utilized for market analysis based on the number of times that location information identifying the point of interest has been received. The report may include information regarding each of the plurality of mobile devices, a number of times that the location information has been received from each of the mobile devices, and/or the point of interest.

In some examples, server 110 may be configured to provide a reward to one or more of the plurality of mobile devices, such as mobile device 120 that has transmitted the location information to server 110. By way of example, but not limitation, the reward associated with store 220 may include a commercial coupon or reward points. Rewards may be issued in various ways. As a non-limiting example, store 220 may issue a reward and provide them to server 110, and server 110 may provide the reward to mobile device 120, such as by transmitting a message that includes the reward. In another example, server 110 may be used to contact an owner of store 220 to allow server 110 to issue the rewards and to provide the issued rewards to mobile device 120 or a user thereof. In yet another example, a third party, such as a beacon system provider (which, under any contact with store 220, is permitted to issue the rewards), may provide the rewards to server 110. For example, the beacon system provider may pay for issuing the rewards to the owner of store 220 and provide them to server 110, and server 110 may provide the issued rewards to mobile device 120, such as by transmitting a message that includes the issued rewards.

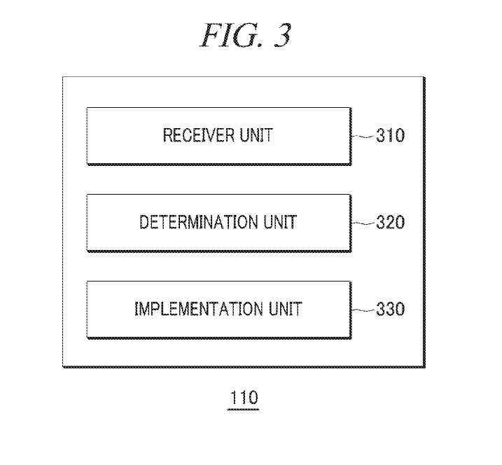

FIG. 3 shows a block diagram of an example server configured to implement a beacon, arranged in accordance with at least some embodiments described herein. Reference may be made to the embodiments depicted and described with reference to FIGS. 1 and 2.

As depicted, server 110 may include a receiver unit 310, a determination unit 320 and an implementation unit 330. Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or virtually any combination thereof.

Receiver unit 310 may be configured to receive, from a plurality of mobile devices, location information that identifies a point interest. In some examples, in or near the point of interest, a mobile device may execute, or run a beacon application, and also turn on a communication module associated with the beacon application, such as a Bluetooth module. In response to operations related to the beacon application, the mobile device may transmit the location information to server 110. The mobile device may transmit the location information identifying the point of interest in response to, for example, executing a beacon application hosted on the mobile device, turning on a communication module associated with the beacon application, switching the beacon application from a background mode to an active mode, and/or turning on a beacon signal reception alarm. In further some examples, mobile device may transmit the location information identifying the point of interest with a flag in response to the operation related to the beacon application. That is, receiver unit 310 may be configured to receive the location information from the mobile device. The received location information may identify a point of interest.

In some examples, the mobile device may determine that the mobile device is in the proximity of the point of interest and then transmit, to server 110, the location information identifying the point of interest. However, instead, server 110 may receive, from the mobile device, the location information indicating that the mobile device is in the proximity of the point of interest and determine that the received location information identifies the point of interest. In some embodiments, the location information may include geographical coordinates, such as GPS coordinates and/or any other type of coordinates. In some examples, server 110 may be configured to receive location information including geographical coordinates from the plurality of mobile devices. Based on the coordinates, server 110 may determine whether the received location information identifies the point of interest or not. In some embodiments, different coordinates of the plurality of mobile devices may identify (or represent) different points of interest. Alternatively, the different coordinates of the plurality of mobile devices may identify a same point of interest.

In some embodiments, receiver unit 310 may be configured to receive the location information that identifies a point of interest from the plurality of mobile devices over a predetermined period of time. The period of time may be predetermined or preset in terms of e.g., minutes, hours, days, and/or weeks, and may be re-set on a rolling basis. That is, the period of time may be re-set upon occurrence of a reconfigurable designated event, e.g., the most recent identification of a particular point of interest, every day, every hour, etc.

Determination unit 320 may be configured to count or determine a number of times that location information identifying the point of interest has been received from one or more of the plurality of mobile devices that is located in a predetermined area proximate to the point of interest. In some examples, determination unit 320 may be configured to determine the number of times that the location information identifying the point of interest has been received, periodically or in a real-time manner. For example, after receiver unit 310 receives the location information identifying the point of interest over a predetermined period of time, or upon receiving the location information by receiver unit 310, determination unit 320 may count or determine the number of times that the location information has been received.

In some examples, determination unit 320 may be configured to determine whether the received location information is transmitted in response to the operation related to the beacon application, and count or determine a number of times that location information in response to the operation related to the beacon application has been received. In further some examples that the mobile device transmits location information with a flag in response to an operation related to a beacon application, determination unit 320 may be configured to count or determine a number of times that location information transmitted in response to the operation related to the beacon application has been received.

Implementation unit 330 may be configured to implement a beacon based on the number of times that location information identifying the point of interest has been received.

In some examples, implementation unit 330 may be configured to notify at least one service provider of the number of times that location information identifying the point of interest has been received from one or more mobile devices. Based on the notified number of times that location information identifying the point of interest has been received from one or more mobile devices, the at least one service provider may provide services, such as, regarding installation of a beacon at the point of interest, a beacon application hosted on the plurality of mobile devices and/or location-based advertisement. By way of example, but not limitation, the at least one service provider may include at least one of mobile payment companies associated with the beacon application, location-based advertisement companies, or any other commercial entities.

In some examples, implementation unit 330 may be configured to count or determine that the number of times that location information identifying the point of interest has been received from one or more mobile devices within a predetermined of time is greater than a predetermined value, and implement the beacon when the number of times is greater than the predetermined value. For example, when implementation unit 330 determines that the number of times that the location information identifying the point of interest is greater than the predetermined value, although a beacon has not been installed at the point of interest yet, implementation unit 330 may be configured to transmit a message at least recommending installation of a beacon to a computing device located at the point of interest. By way of example, but not limitation, implementation unit 330 may transmit the message to at least one of beacon system provider, a store located at the point of interest, a commercial entity associated with the point of interest. The message recommend installation of beacon 220 since the number of mobile devices executing, or running a beacon application within communication range of store within a predetermined period of time would appear to justify the effort and investment to do so.

In some examples, implementation unit 330 may be configured to calculate, for the point of interest, a ratio of the number of times that location information received from one or more mobile device identifying the point of interest has been received relative to a floating population around the point of interest over a predetermined period of time. In such examples, implementation unit 330 may implement beacon in response to the determination that the calculated ratio is greater than a predetermined value.

In some examples, implementation unit 330 may be configured to generate, based on the number of times that location information identifying the point of interest has been received, a report that may be utilized for market analysis. The report may include information regarding each of the plurality of mobile devices, a number of times that the location information has been received from the each of the mobile devices, and/or the point of interest.

In some examples, implementation unit 330 may be configured to provide a reward to one or more of the plurality of mobile devices that have transmitted the location information to server 110. By way of example, but not limitation, the reward associated with the point of interest may include a commercial coupon or reward points. Rewards may be issued in various ways. In an example, a store at the point of interest may issue a reward and provide them to server 110, and server 110 may provide the reward to one or more of the plurality of mobile devices, such as by transmitting message that includes the reward. In another example, server 110 may be used to contact an owner of the store to allow server 110 to issue the rewards, and implementation unit 330 may provide the issued rewards to one or more of the plurality of mobile devices that have transmitted the location information to server 110. In yet another example, a third party, such as beacon system provider (which, under any contact with the store, is permitted to issue the rewards), may provide the rewards to server 110. For example, the beacon system provider may pay the owner of the store to issue the rewards and provide them to server 110, and implementation unit 330 may provide the issued rewards to the one or more of the plurality of mobile devices, such as by transmitting a message including the issued rewards.

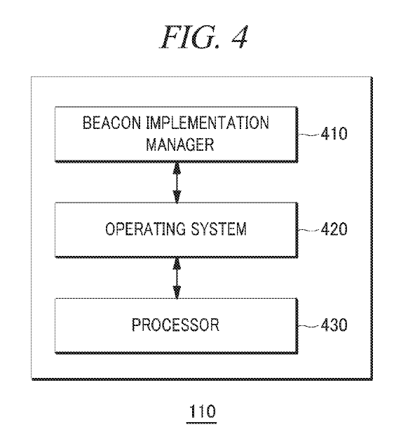

FIG. 4 shows a block diagram of another example server configured to implement a beacon, arranged in accordance with at least some embodiments described herein. Reference may be made to the embodiments depicted and described with reference to FIGS. 1 to 3.

As depicted, server 110 may include a beacon implementation manager 410, an operating system 420 and a processor 430. Beacon implementation manager 410 may be adapted to operate on operating system 420 such that the beacon implementation scheme, as described herein, may be provided. Operating system 420 may allow beacon implementation manager 410 to manipulate processor 430 to implement a beacon as described herein.

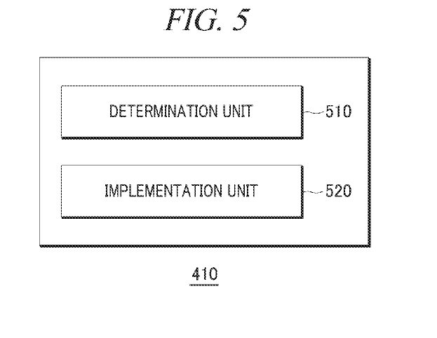

FIG. 5 shows a block diagram of example beacon implementation manager 410 to manage beacon implementation, arranged in accordance with at least some embodiments described herein. Reference may be made to the embodiments depicted and described with reference to FIGS. 1 to 4.

As depicted, beacon implementation manager 410 may include a determination unit 510 and an implementation unit 520. In response to operations related to the beacon application, the one or more of the plurality of mobile devices may transmit the location information to server 110. The one or more of the plurality of mobile devices may transmit the location information identifying the point of interest in response to, for example, executing a beacon application hosted on the one or more of the plurality of mobile devices, turning on a communication module associated with the beacon application, switching the beacon application from a background mode to an active mode, and/or turning on a beacon signal reception alarm. Determination unit 510 may be adapted to determine a number of times that the location information identifying the point of interest has been received from one or more the plurality of mobile devices, in accordance with various example methods as described above. Further, implementation unit 520 may be adapted to implement a beacon based on the number of times that location information identifying the point of interest has been received, and various example methods described above may be utilized in the implementation of the beacon.

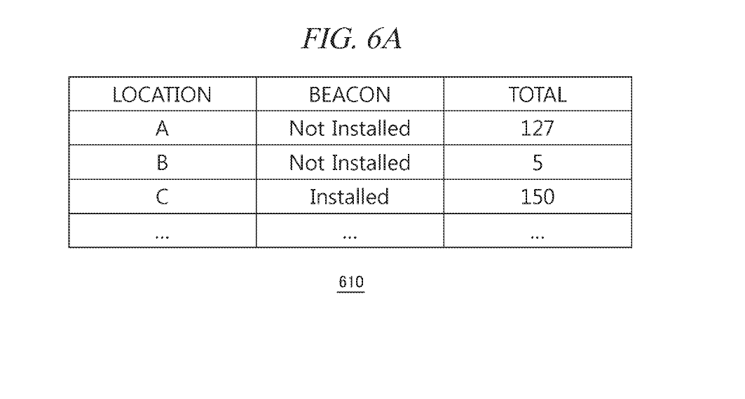

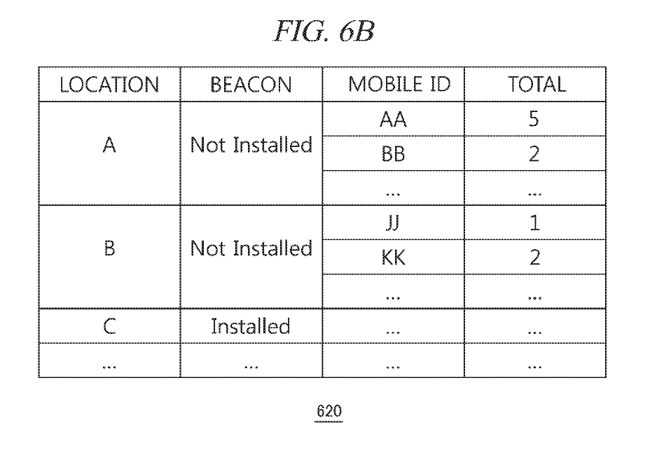

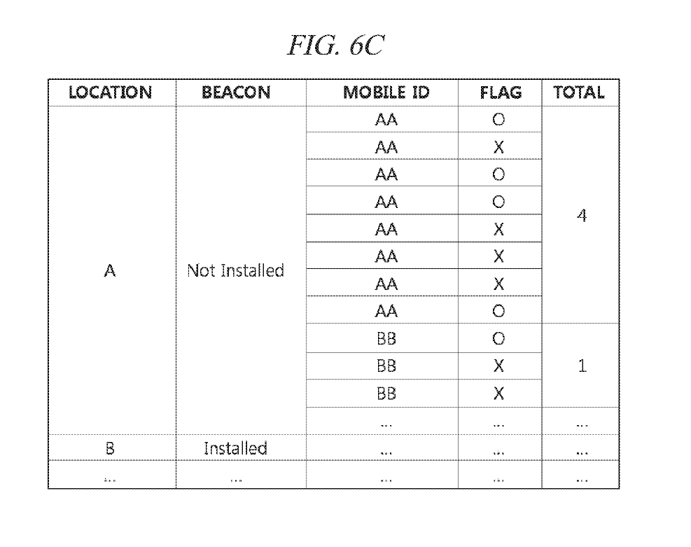

FIGS. 6A and 6B illustrate databases of a server that may be used to determine the number of times that location information identifying a point of interest has been received, arranged in accordance with at least some embodiments described herein. Reference may be made to the embodiments depicted and described with reference to FIGS. 1-5.

FIG. 6A shows an example database 610 in which the number of times that the location information has been received is determined for each of Locations A, B, C, etc. In some examples, the points of interest may include Locations A and B at which any beacon has not been installed yet, and the server may be configured to implement a beacon if the number of times that location information identifying one of points of interest, i.e., Location A or B, has been received is greater than a predetermined value, i.e., 100. The server may receive the location information identifying Location A or B from a plurality of mobile devices. The server may determine that the number of times that location information identifying Location A has been received is 127. Also, the server may determine that the location information identifying Location A has been received is greater than 100, and implement a beacon for Location A. For example, the server may transmit a message indicating that the number of potential customers using a beacon application is expected to exceed 100, and it is recommended to install a beacon at the point of interest. In the meantime, since the number of times that location information identifying Location B has been received, i.e., 5, is not greater than 100, the server may not implement a beacon for Location B.

FIG. 6B shows another example database 620 in which the number of times that the location information has been received from each of a plurality of mobile devices is determined for each of Locations A, B, C, etc. As depicted, a database 620 additionally includes mobile identification (ID) (e.g., AA, BB, . . . , JJ, etc.) determined for each of Locations A, B, C, etc. In some examples, the point of interest may be Location A at which any beacon has not been installed yet. The server may receive the location information identifying Location A from a plurality of mobile devices including mobile devices having mobile IDs AA, BB or etc., hereafter referred to as mobile devices AA, BB, etc. For example, mobile device AA may execute, and/or run a beacon application, turn on a communication module associated with the beacon application, switch the beacon application from a background mode to an active mode, turn on a beacon signal reception alarm, etc. five (5) times at Location A, and a server may receive location information from mobile device AA each of the five (5) times. Then, the server may determine that that location information identifying Location A has been received from mobile device AA 5 times within the predetermined period of time. Similarly, the server may determine that location information identifying Location A has been received from mobile device BB only 2 times within the predetermined period of time. In some examples, the server may provide rewards associated with the point of interest to a mobile device based on the determined number of times. The reward may include a commercial coupon or reward points based on the determined number of times. For example, the server may provide more valuable rewards associated with Location A to mobile device AA than to mobile device BB.

FIG. 6C shows yet another example database 630 in which the number of times that the location information has been received from each of a plurality of mobile devices is determined for each of Locations A, B, etc. As depicted, a database 630 includes mobile identification (ID) (e.g., AA, BB, . . . , etc.) determined for each of Locations A, B, etc. Further, database 630 indicates whether the received location information includes a flag. In some examples, a mobile device may transmit the location information identifying Location A, B or etc. together with a flag in response to an operation related to a beacon application hosted on the mobile device such as, for example, executing the beacon application; turning on a communication module associated with the beacon application; switching the beacon application from a background mode to an active mode; or turning on a beacon signal reception alarm. Thus, the location information with the flag may indicate that a user of the mobile device has intended to use the beacon application hosted on the mobile device. In some other embodiments, the mobile device may transmit the location information without any initiation by the user of the mobile device. In such cases, the mobile device may not transmit a flag together with the location information. By way of example, but not limitation, the mobile device may periodically transmit the location information identifying Location A, B, etc. without a flag while the beacon application is running on the mobile device.

The server may receive the location information identifying Location A with a flag (indicated as “O” in FIG. 6C) or the location information identifying Location A without a flag (indicated as “X” in FIG. 6C) from the plurality of mobile devices including mobile devices AA, BB. Additionally or alternatively, the server may be configured to determine whether or not the received location information has been transmitted in response to, for example, one or more of the above-described operations, and if not, the server may be configured to determine that the received location information includes a flag. Then, the server may determine the number of times that the location information with the flag has been received.

For example, mobile device AA may execute a beacon application, turn on a communication module associated with the beacon application, switch the beacon application from a background mode to an active mode, turn on a beacon signal reception alarm, etc. four (4) times at Location A, and a server may receive location information from mobile device AA each of the four times. Further, the server may periodically receive location information from mobile device AA each of four times. Then, the server may determine that the location information identifying Location A with the flag has been received from mobile device AA four times within the predetermined period of time. Similarly, the server may receive location information identifying Location A from mobile device BB each of the three (3) times, but determine that location information identifying Location A with a flag has been received from mobile device BB only once. The server may be configured to implement a beacon based on the number of times that location information identifying Locations A, B, etc., has been received.

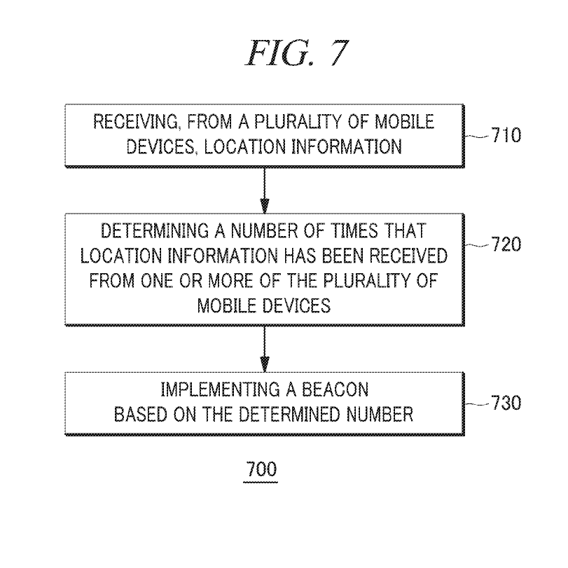

FIG. 7 shows an example flow diagram of a process to implement a beacon, arranged in accordance with at least some embodiments described herein.

Process 700 may be implemented in a server such as server 110 including at least one of receiver unit 310, determination unit 320 or implementation unit 330. Process 700 may also be implemented by computer programs or program modules that may be adapted to implement a beacon and hosted by server 110, such as beacon implementation manager 410 including determination unit 510 and implementation unit 520. Thus, reference may be made to the embodiments depicted and described with reference to FIGS. 1-5. Process 700 may include one or more operations, actions, or functions as illustrated by one or more blocks 710, 720 and/or 730. Although illustrated as discrete blocks, various blocks may be divided into additional blocks, combined into fewer blocks, or eliminated, depending on the desired implementation. Processing may begin at block 710.

At block 710 (Receiving, from a Plurality of Mobile Devices, Location Information), server 110 and/or receiver unit 310 may receive, from a plurality of mobile devices, location information. In some examples, the location information may include geographical coordinates, such as, global positioning system (GPS) coordinates and/or any other coordinates. Server 110 may determine, based on the coordinates, whether the location information identifies the point of interest. In some examples, server 110 may receive the location information that identifies a point of interest from a plurality of mobile devices over a period of time. The period of time may be predetermined or preset. Processing may continue from block 710 to block 720.

At block 720 (Determining a Number of Times that Location Information Has Been Received From One or More of The Plurality of Mobile Devices), server 110 and/or determination unit 320 may determine a number of times that location information identifying the point of interest has been received from one or more of a plurality of mobile devices. In some examples, server 110 and/or determination unit 320 may determine the number of times that the location information has been received, periodically or in a real-time manner during a predetermined period of time. Processing may continue from block 720 to block 730.

At block 730 (Implementing a Beacon based on the Determined Number), server 110 and/or implementation unit 330 may implement a beacon based on the number of times that location information identifying the point of interest has been received. In some examples, server 110 may notify a service provider of the number of times that location information identifying the point of interest has been received from one or more mobile devices. Based on the notified number of times that location information identifying the point of interest has been received from one or more mobile devices, the service provider may provide services, such as, regarding installation of a beacon at the point of interest, a beacon application hosted on the plurality of mobile devices and/or location-based advertisement. By way of example, but not limitation, the service provider may include at least one of mobile payment companies associated with a beacon application, location-based advertisement companies, or any other commercial entities.

In some examples, server 110 may determine that the number of times that location information identifying the point of interest has been received from one or more mobile devices within a predetermined period of time is greater than a predetermined value, and implement beacon in response to the determination that the number of times is greater than the predetermined value. When the number of times that location information identifying the point of interest at which a beacon has not been installed yet, has been received is greater than a predetermined value, server 110 may transmit a message at least recommending installation of a beacon to a computing device located at the point of interest. For example, the message may recommend installation of a beacon at the point of interest since the number of mobile devices executing, or running a beacon application within a predetermined period of time would appear to justify the effort and investment to do so.

In some examples, server 110 may receive, from one or more mobile devices, the location information from the plurality of times over a predetermined period of time, and calculate, for the point of interest, a ratio of the number of times that location information identifying the point of interest has been received relative to a floating population around the point of interest over the predetermined period of time. In such examples, server 110 may be configured to implement a beacon in response to the determination that the calculated ratio is greater than the predetermined value.

In some examples, server 110 may generate a report which, for example, may be utilized for marketing materials, based on the number of times that location information identifying the point interest has been received. The report may include information regarding each of the plurality of mobile devices, a number of times that the location information has been received from the each of the mobile devices, and/or the point of interest.

In some examples, server 110 may provide a reward to the one or more of the plurality of mobile devices. By way of example, but not limitation, the reward associated with the point of interest may include a commercial coupon or reward points.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

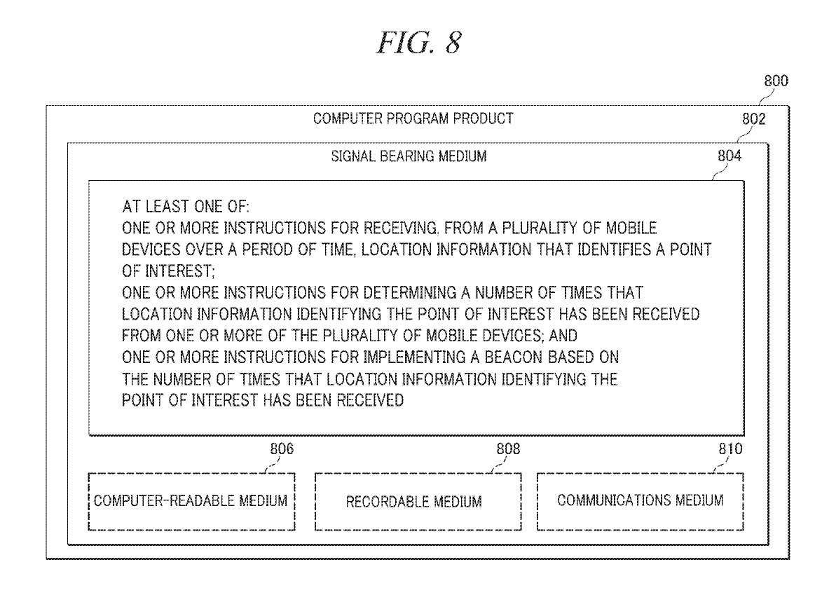

FIG. 8 illustrates an example computer program product that may be utilized to implement a beacon, arranged in accordance with at least some embodiments described herein.

As depicted, program product 800 may include a signal bearing medium 802. Signal bearing medium 802 may include one or more instructions 804 that, when executed by, for example, server 110 may provide the functionality described above with respect to FIGS. 1-7. By way of example, instructions 804 may include: one or more instructions for receiving, from a plurality of mobile devices over a period of time, location information that identifies a point of interest; one or more instructions for determining a number of times that location information identifying the point of interest has been received from one or more of the plurality of mobile devices; and one or more instructions for implementing a beacon based on the number of times that location information identifying the point of interest has been received.

In some implementations, signal bearing medium 802 may encompass a computer-readable medium 806, such as, but not limited to, a hard disk drive, a CD, a DVD, a digital tape, memory, etc. In some implementations, signal bearing medium 802 may encompass a recordable medium 808, such as, but not limited to, memory, read/write (R/W) CDs, R/W DVDs, etc. In some implementations, signal bearing medium 802 may encompass a communications medium 810, such as, but not limited to, a digital and/or an analog communication medium (e.g., a fiber optic cable, a waveguide, a wired communications link, a wireless communication link, etc.). Thus, for example, program product 800 may be conveyed to one or more modules of server 110 by an RF signal bearing medium 802, where the signal bearing medium 802 is conveyed by a wireless communications medium 810 (e.g., a wireless communications medium conforming with the IEEE 802.11 standard).

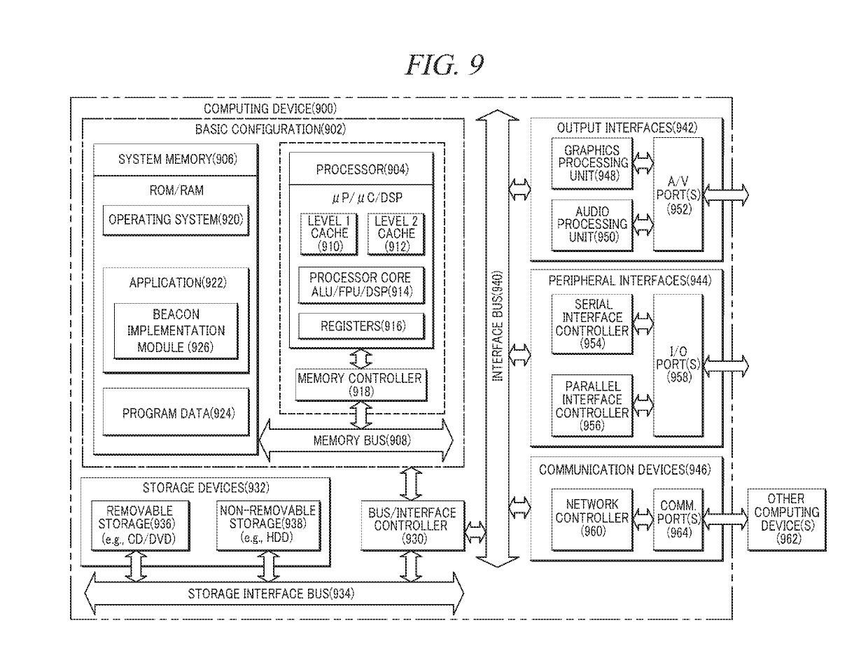

FIG. 9 is a block diagram illustrating an example computing device that may be utilized to implement a beacon, arranged in accordance with at least some embodiments described herein.

In a very basic configuration 902, computing device 900 typically includes one or more processors 904 and a system memory 906. A memory bus 908 may be used for communicating between processor 904 and system memory 906.

Depending on the desired configuration, processor 904 may be of any type including but not limited to a microprocessor (VP), a microcontroller (PC), a digital signal processor (DSP), or any combination thereof. Processor 904 may include one or more levels of caching, such as a level one cache 910 and a level two cache 912, a processor core 914, and registers 916. An example processor core 914 may include an arithmetic logic unit (ALU), a floating point unit (FPU), a digital signal processing core (DSP Core), or any combination thereof. An example memory controller 918 may also be used with processor 904, or in some implementations memory controller 918 may be an internal part of processor 904.

Depending on the desired configuration, system memory 906 may be of any type including but not limited to volatile memory (such as RAM), nonvolatile memory (such as ROM, flash memory, etc.) or any combination thereof. System memory 906 may include an operating system 920, one or more applications 922, and program data 924.

Application 922 may include a beacon implementation module 926 that may be arranged to perform the operations and/or functions as described herein including the actions described with respect to server 110 architectures as shown in FIGS. 3-5 or including the actions described with respect to the flow chart shown in FIG. 7. Program data 924 may include any data that may be useful for providing the beacon implementation scheme as is described herein. In some examples, application 922 may be arranged to operate with program data 924 on an operating system 920 such that the beacon implementation scheme as described herein may be provided.

Computing device 900 may have additional features or functionality, and additional interfaces to facilitate communications between basic configuration 902 and any required devices and interfaces. For example, a bus/interface controller 930 may be used to facilitate communications between basic configuration 902 and one or more data storage devices 932 via a storage interface bus 934. Data storage devices 932 may be removable storage devices 936, non-removable storage devices 938, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 906, removable storage devices 936 and non-removable storage devices 938 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 900. Any such computer storage media may be part of computing device 900.

Computing device 900 may also include an interface bus 940 for facilitating communication from various interface devices (e.g., output devices 942, peripheral interfaces 944, and communication devices 946) to basic configuration 902 via bus/interface controller 930. Example output devices 942 include a graphics processing unit 948 and an audio processing unit 950, which may be configured to communicate to various external devices such as a display or speakers via one or more A/V ports 952. Example peripheral interfaces 944 include a serial interface controller 954 or a parallel interface controller 956, which may be configured to communicate with external devices such as input devices (e.g., keyboard, mouse, pen, voice input device, touch input device, etc.) or other peripheral devices (e.g., printer, scanner, etc.) via one or more I/O ports 958. An example communication device 946 includes a network controller 960, which may be arranged to facilitate communications with one or more other computing devices 962 over a network communication link via one or more communication ports 964.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method performed under control of a server, the method comprising:
receiving, from a plurality of mobile devices over a period of time, location information that identifies a point of interest;
determining a number of times that the location information that identifies the point of interest has been received from one or more of the plurality of mobile devices; and
implementing, at the point of interest, a beacon based on the number of times that the location information that identifies the point of interest has been received, wherein the implementing the beacon includes transmitting a message associated with installation, at the point of interest, of the beacon based on a determination that the number of times is greater than a specific value.

2. The method of claim 1, wherein the receiving the location information includes receiving global positioning system (GPS) coordinates from the plurality of mobile devices over the period of time.

3. The method of claim 1, wherein the receiving the location information includes receiving a location information with a flag, wherein the location information with the flag is transmitted by the plurality of mobile devices in response to an operation related to a beacon application hosted on the plurality of mobile devices.

4. The method of claim 1, further comprising, in response to the receiving, determining that the received location information is transmitted by the plurality of mobile devices in response to an operation related to a beacon application hosted on the plurality of mobile devices.

5. The method of claim 1, wherein the implementing includes notifying at least one service provider of the number of times that the location information that identifies the point of interest has been received.

6. The method of claim 1, wherein the implementing includes
implementing the beacon based on the determination that the number of times is greater than the specific value.

7. (canceled)

8. The method of claim 1, wherein the transmitting includes transmitting the message to at least one of a beacon system provider, a store at the point of interest, or a commercial entity associated with the point of interest.

9. The method of claim 1, wherein the implementing includes:
calculating, for the point of interest, a ratio of the number of times that the location information that identifies the point of interest has been received to a floating population around the point of interest over the period of time;
determining that the calculated ratio for the point of interest is greater than a another specific value; and
implementing the beacon based on the determination that the calculated ratio is greater than the another specific value.

10. The method of claim 1, wherein the implementing includes providing a reward to the one or more of the plurality of mobile devices.

11. The method of claim 10, wherein the reward includes at least one of a commercial coupon or reward points.

12. A server, comprising:
a receiver configured to receive, from a plurality of mobile devices, location information that identifies a point of interest;
a determination unit coupled to the receiver and configured to determine a number of times that the location information that identifies the point of interest has been received by the receiver from one or more of the plurality of mobile devices; and
an implementation unit configured to implement, at the point of interest, a beacon based on the number of times that the location information that identifies the point of interest has been received,
wherein to implement the beacon, the implementation unit is configured to transmit a message associated with installation, at the point of interest, of the beacon based on a determination that the number of times is greater than a specific value.

13. The server of claim 12, wherein the received location information includes global positioning system (GPS) coordinates.

14. The server of claim 13, wherein the receiver is configured to receive the location information over a period of time.

15. The server of claim 14, wherein the implementation unit is configured to:
calculate, for the point of interest, a ratio of the number of times that location information that identifies the point of interest has been received to a floating population around the point of interest over the period of time;
determine that the calculated ratio for the point of interest is greater than another specific value; and
implement the beacon based on the determination that the calculated ratio is greater than the another specific value.

16. The server of claim 12, wherein the implementation unit is further configured to notify at least one service provider of the number of times that location information that identifies the point of interest has been received.

17. The server of claim 12, wherein the implementation unit is configured to
implement the beacon based on the determination that the number of times is greater than the specific value.

18. (canceled)

19. The server of claim 12, wherein the implementation unit is configured to transmit the message to at least one of a beacon system provider, a store at the point of interest, or a commercial entity associated with the point of interest.

20. The server of claim 12, wherein the implementation unit is further configured to provide a reward to the one or more of the plurality of mobile devices, wherein the reward includes at least one of a commercial coupon or reward points.

21. A computer-readable storage medium having stored thereon computer-executable instructions that, in response to execution, cause a server to perform or control performance of operations that comprise:
detect location information, received from a plurality of mobile devices over a period of time, that identifies a point of interest;
determine a number of times that the location information that identifies the point of interest has been received from one or more of the plurality of mobile devices; and
implement, at the point of interest, a beacon based on the number of times that the location information that identifies the point of interest has been received, wherein the implementation of the beacon includes transmission of a message associated with installation, at the point of interest, of the beacon based on a determination that the number of times is greater than a specific value.

22. The computer-readable storage medium of claim 21, wherein the operations to implement include:
implement the beacon based on the determination that the number of times is greater than the specific value.

23. (canceled)

24. The computer-readable storage medium of claim 21, wherein the operations to implement include:
provide a reward to the one or more of the plurality of mobile devices, wherein the reward includes at least one of a commercial coupon or reward points.
